(19) United States
(12) Patent Application Publication
(10) Pub. No.: US 2025/0214191 A1
(43) Pub. Date: Jul. 3, 2025

(54) CONFORMAL FLEXIBLE POLISHING METHOD FOR MICRO LENS ARRAY MOLD

(71) Applicants: DALIAN UNIVERSITY OF TECHNOLOGY, Dalian, Liaoning (CN); DALIAN UNIVERSITY OF TECHNOLOGY NINGBO RESEARCH INSTITUTE, Ningbo, Zhejiang (CN)

(72) Inventors: Jiang GUO, Dalian, Liaoning (CN); Renke KANG, Dalian, Liaoning (CN); Pengfei ZHANG, Dalian, Liaoning (CN); Linguang LI, Dalian, Liaoning (CN); Zhe YANG, Dalian, Liaoning (CN); Dongming GUO, Dalian, Liaoning (CN)

(21) Appl. No.: 18/560,577

(22) PCT Filed: Feb. 6, 2023
(86) PCT No.: PCT/CN2023/074508

§ 371 Date: Dec. 24, 2024

(30) Foreign Application Priority Data
Aug. 30, 2022 (CN) 202211044430.4

(51) Int. Cl. B24B 1/00; B24B 29/02; B24B 49/04

(52) U.S. Cl. CPC B24B 1/005; B24B 29/02; B24B 49/04

(57) ABSTRACT

The present invention relates to a conformal flexible polishing method for a micro lens array mold, which realizes conformal flexible polishing. Solution 1: a magnet is installed below a workpiece so that the prepared magnetic slurry is fitted with the surface of the workpiece under the action of magnetic field force to produce a contact pressure; a magnetic polishing tool is installed above the workpiece, and the tool is magnetized; the polishing tool rotates, and the magnetic slurry on the tip end of the tool forms a spherical polishing head. Solution 2: a shear thickening slurry is used, a ball end tool is installed above the workpiece, and the shear thickening slurry is driven through the high-speed rotation of the ball end tool to rotate and produce a relative shear motion so as to carry out polishing under the action of the shear thickening effect.

### TECHNICAL FIELD

The present invention belongs to the field of precision/ultra-precision machining, and relates to a conformal flexible polishing method for a micro lens array mold.

### BACKGROUND

Micro-nano structural devices are widely used in microsystems due to the advantages of miniaturization, integration and lightweight, and play a great role in the fields of micro-optics, optical engineering, tribology, surface engineering, biology and biomedical engineering. The precision glass forming technology is the most effective method to fabricate micro-nano structural devices on the premise of an available high-precision micro lens array mold matched therewith.

However, the micro lens array mold has the characteristics of very small size (with the size of a single feature of 0.1-1000 μm) and very high surface quality, which increases the machining and manufacturing difficulties to a large extent. The traditional machining methods such as single-point diamond turning can obtain nanoscale surface roughness, but defects such as tool marks and scratches will be left on the surface of the mold in the machining process, affecting the reproduction accuracy of micro-nano structural devices, so subsequent polishing is still needed.

Polishing mainly refers to a modifying method using mechanical, chemical or electrochemical action to reduce the surface roughness of workpieces so as to obtain a bright and flat surface, with the main purpose of removing surface defects generated by the previous process to reduce the shape error. A flat workpiece is often polished by the fixed abrasive pad or loose abrasives, and the polishing pad can be well matched with the shape of the workpiece to obtain a better polishing effect. Spherical and free-form workpieces are often polished by a small tool head by making a grinding head with the same curvature as the workpieces. The traditional methods cannot polish micro lens array molds due to the size limitation of a single feature.

Chinese invention patent (CN 103495917 B), with the title of a magnetic suspension polishing device for aspheric optics machining. The patent provides a magnetic suspension polishing device for aspheric optics machining, which is composed of a magnetic suspension polishing head mechanism and a triaxial movement mechanism and needs no circulation of polishing solution in the machining process. However, the device is only limited to the polishing of a larger plane, has single structure and function and cannot polish the surface of a workpiece with a certain curvature, and it is difficult to ensure high surface accuracy.

Chinese invention patent (CN 100431790 C), with the title of a machining method for aspherical optics of optical glass and silicon single crystal. The patent provides a machining technology for optics, which uses a butterfly disk to grind the workpiece to remove small bumps on the surface of the workpiece through the fit between the disk and the surface of the workpiece as well as relative movement, so as to gradually form a smooth surface. However, in the machining process, the flexibility of the disk is poor, and it is difficult to adapt to the changing curvature radius of the polished surface.

Chinese invention patent (CN 105500181 B), with the title of a polishing device, a substrate processing device and a polishing method. The patent provides a polishing device, which is mainly composed of a grinding unit, a trim table, a nozzle and a polishing head and can restrain the damage of the substrate and carry out grinding during polishing. However, the structure of the device is relatively fixed, it is not convenient to move the polishing position, and the polishing solution is not reasonably recovered in the machining process, which may pollute the environment.

### SUMMARY

Aiming at the problem that it is difficult to machine the micro lens array mold by the traditional polishing methods, the present invention proposes a new conformal flexible polishing method for a micro lens array mold, which can maintain the original shape accuracy of the micro lens array mold and obtain higher surface quality.

To achieve the above purpose, the present invention adopts the following technical solution:

A conformal flexible polishing method for a micro lens array mold, comprising the following steps:

### Step 1: Conducting Initial Inspection of a Micro Lens Array Mold 3

The initial conditions of the micro lens array mold 3 (workpiece) to be machined are inspected, including the size, initial surface roughness and initial topography of feature points 12 on the micro lens array mold 3, and the initial shape of the micro lens array mold 3, wherein the size of the feature points 12 is in micron order.

### Step 2: Preparing a Polishing Slurry

When the machining tool is a tip tool 1, it is necessary to prepare magnetic slurry. Specifically, diamond abrasive 7 with a certain particle size and iron powder 6 are mixed according to the mass ratio of 4:1 to obtain magnetic slurry, a coupling agent is added, and the diamond abrasive 7 is bonded to the surface of the iron powder 6 through the coupling agent. The additive amount of the coupling agent is 1 ml for every 5 g of magnetic slurry; and the coupling agent is silane coupling agent. The particle size of the diamond abrasive 7 is 3-5 μm.

Optionally, for a magnetic mold, the shear thickening polishing method can be selected. The machining tool is replaced with a ball end tool 8, and at this moment, it is necessary to prepare a shear thickening slurry 11 for producing a shear thickening effect. Specifically, the shear thickening slurry comprises abrasive particles 10, a shear thickening phase and deionized water. The shear thickening phase is polyhydroxylated polymer 9, with the mass fraction of 45-52 wt %; the abrasive particles 10 are one or a combination of aluminum oxide, silicon carbide, diamond, cerium oxide and zirconium oxide, with the particle size of 1-10 μm and the proportion of 10-15 wt %; and the rest is deionized water. The abrasive particles 10, the shear thickening phase and the deionized water are mixed well by ultrasound in a certain proportion.

### Step 3: Installing Tools

The magnetic slurry is placed on the upper surface of the micro lens array mold 3. The micro lens array mold 3 is installed on a triaxial movement platform; and the tip tool 1 is installed on a motor 16 through a collet 21 so as to rotate. The bottom machining end of the tip tool 1 is a tip end, the tip tool 1 is magnetically conductive, and the tip tool 1 is magnetized by adsorbing a spherical magnet 22 to the top thereof to possess the ability of adsorbing magnetic slurry; a magnet 5 is installed below the micro lens array mold 3 so that the magnetic slurry is fitted with the surface of the workpiece under the action of magnetic field force to produce a certain contact pressure; and the motor 16 is installed on the Z axis 20 of the triaxial movement platform so as to move along the axial direction of the micro lens array mold 3.

Optionally, the shear thickening slurry 11 is placed on the upper surface of the micro lens array mold 3. The micro lens array mold 3 is installed on a triaxial movement platform; and the ball end tool 8 is installed on the motor 16 through the collet 21 so as to rotate. The bottom machining end of the ball end tool 8 is spherical, and the diameter of the machining end is smaller than that of the micro lens array feature points 12. The ball end tool 8 is driven by the motor 16 to rotate at a high speed so as to drive the shear thickening slurry 11 to rotate and produce a relative shear motion with the feature points 12. When the shear rate reaches a certain value, a shear thickening effect is produced. At this moment, the abrasive particles 10 in the shear thickening slurry complete polishing of the feature points 12 under the coating of the polyhydroxylated polymer 9. The motor 16 is installed on the Z axis 20 of the triaxial movement platform so as to move along the axial direction of the micro lens array mold 3.

### Step 4: Setting Polishing Parameters

The polishing parameters to be set mainly include the gap between the micro lens array mold 3 and the tip tool 1, the motion track 13 of the micro lens array mold 3 and the speed of the motor 16, and the above parameters are confirmed according to the actual conditions, wherein the polishing gap between the micro lens array mold 3 and the tip tool 1 is adjusted through the Z axis 20 of the triaxial platform so that the tip tool 1 always moves along a polishing path 2 to ensure no damage to the shape accuracy in the polishing process; and the micro lens array mold 3 can carry out XY two-dimensional planar motion through the triaxial platform according to the motion track 13.

The tip tool 1 rotates, the magnetic slurry 7 on the tip end of the tool 1 forms a spherical polishing head under the action of magnetic force and centrifugal force, and the polishing head has flexibility and can be adapted to the curvature of the feature points 12 of the micro lens array mold 3 to achieve the purpose of maintaining the shape of the micro lens array mold 3. Material removal is achieved through the magnetic field force generated by the magnet 5 below the workpiece on the magnetic slurry and the relative motion generated between the tip tool 1 and the micro lens array mold 3 after rotation to remove the defects such as scratches and tool marks on the surface of the micro lens array mold 3 so as to obtain a high-quality surface. All the feature points 12 of the micro lens array mold 3 are polished by controlling the tip tool 1 to move along the motion track 13.

### Step 5: Conducting Quality Inspection of the Mold

The polished micro lens array mold 3 is inspected, including the size of the feature points 12 of the micro lens array mold 3, the surface roughness and topography after polishing, and the shape of the polished micro lens array mold 3, to determine whether the machining requirements are met. If yes, the next step is executed; otherwise, step 4 is executed for polishing and inspection again until the machining requirements are met.

### Step 6: Finishing.

Further, the diamond abrasive 7 in the present invention can be one or a combination of aluminum oxide, silicon carbide, diamond, cerium oxide and zirconium oxide based on the material of the micro lens array mold 3.

Further, the present invention can add chemical action in the polishing process to introduce a chemical field for compounding.

The present invention has the following beneficial effects:
(1) Aiming at the characteristic of difficulty in polishing of the micro lens array mold 3, the present invention proposes a new conformal flexible polishing method;
(2) The tip tool 1 or the ball end tool 8 is used, which is free from the limitation of small size of the feature points 12 of the micro lens array mold 3 and can obtain a high-quality surface at the same time of maintaining the original shape accuracy;
(3) The magnetic field assisted polishing method and the shear thickening polishing method are adopted, which can polish non-magnetic and magnetic materials, thus getting rid of the material limitation of the mold;
(4) Multi-field coupling can be carried out to further improve the polishing quality and efficiency.

### DESCRIPTION OF DRAWINGS

FIG. 1 is a flow chart of a conformal flexible polishing method for a micro lens array mold;

FIG. 2 is a schematic diagram of magnetic field assisted conformal flexible polishing of a micro lens array mold;

FIG. 3 is a schematic diagram of shear thickening conformal flexible polishing of a micro lens array mold;

FIG. 4 is a schematic diagram of a micro lens array mold;

FIG. 5 is a schematic diagram of a polishing path;

FIG. 6 is a schematic diagram of polishing of embodiment 1;

In the figures: 1 tip tool; 2 polishing path; 3 micro lens array mold; 4 magnetic induction line; 5 magnet; 6 iron powder; 7 diamond abrasive; 8 ball end tool; 9 polyhydroxylated polymer; 10 abrasive particles; 11 shear thickening slurry; 12 feature point; 13 motion track; 14 marble gantry; 15 motor base; 16 motor; 17 X axis; 18 Y axis; 19 marble platform; 20 Z axis; 21 collet; and 22 spherical magnet.

### DETAILED DESCRIPTION

The principle and technical solution of the present invention will be clearly and completely described below in combination with embodiments and drawings. The described embodiments are merely part of the embodiments of the present invention, not all of the embodiments. Based on the following embodiments, other embodiments obtained by those ordinary skilled in the art without contributing creative labor will belong to the protection scope of the present invention.

### Embodiment 1

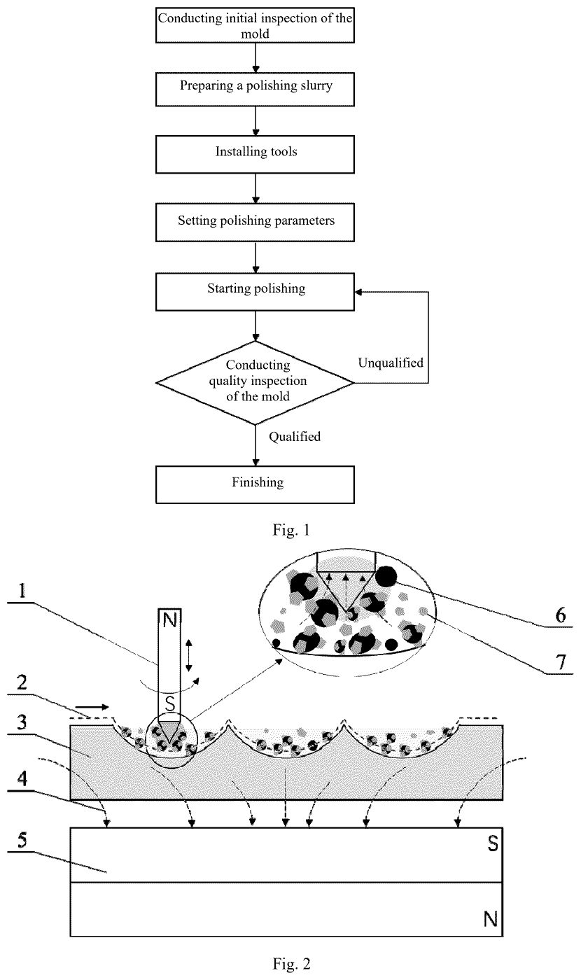

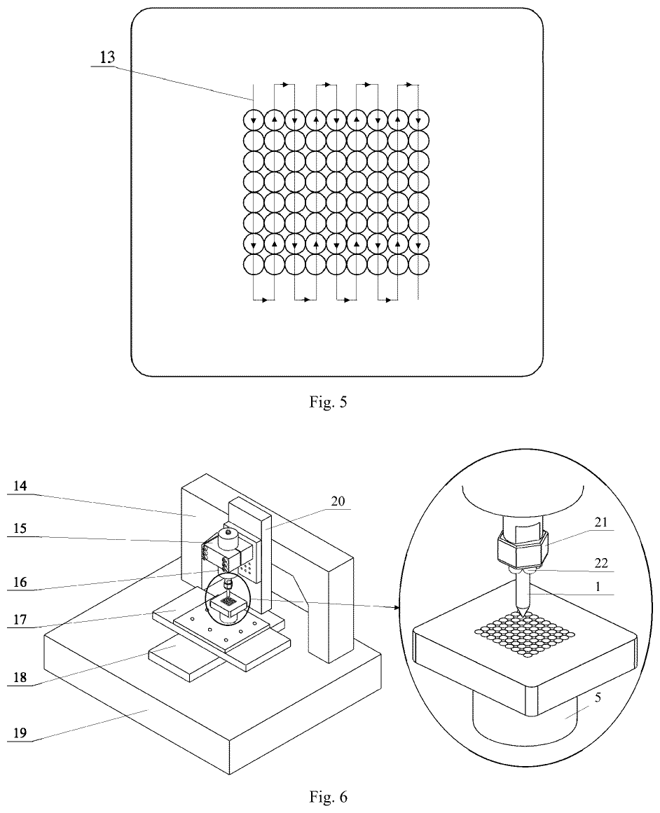

Referring to FIG. 1, FIG. 2, FIG. 4, FIG. 5 and FIG. 6, the device shown in FIG. 6 is used to perform magnetic field assisted conformal flexible polishing of the micro lens array mold 3. The micro lens array mold 3 is an optical glass precision forming mold, which has 8×9 spherical feature points 12, and a single feature point 12 has the diameter of 800 μm and the depth of 120 μm.

A magnetic field assisted conformal flexible polishing method based on a micro lens array mold comprises the following steps:

Step 1: conducting initial inspection of the mold.

The initial conditions of the micro lens array mold are inspected, including the size, initial surface roughness and initial topography of feature points 12 on the micro lens array mold, and the initial shape of the micro lens array mold 3, through a ZYGO white-light interferometer, an MITAKA surface profiler, an ultra-depth microscope, etc.

Step 2: preparing magnetic polishing slurry.

Diamond abrasive 7 with the particle size of 3-5 μm and iron powder 6 are mixed according to the mass ratio of 4:1, a coupling agent is added, and the diamond abrasive 7 is bonded to the surface of the iron powder 6 through the coupling agent to prevent the abrasive 7 from being thrown out during rotation. Meanwhile, the magnetic force acting on the iron powder 6 can press the abrasive 7 against the surface of the micro lens array mold 3, creating a polishing pressure. The additive amount of the coupling agent is 1 ml for every 5 g of magnetic slurry; and the coupling agent is silane coupling agent.

Step 3: installing tools.

The magnetic polishing slurry is placed on the upper surface of the micro lens array mold 3.

The micro lens array mold 3 and the tip tool 1 are installed, and the installation requirement is that the micro lens array mold 3 is installed on the X axis 17 of the triaxial platform, the two are bonded by double-sided tape, and by controlling the X axis 17 and Y axis 18 of the triaxial platform, the micro lens array mold 3 can move according to the motion track 13. The main body of the triaxial platform is composed of a marble gantry 14 and a marble platform 19, wherein the Y axis 18 is installed on the marble platform 19, the X axis 17 is installed on the Y axis 18, and the Z axis 20 is fixed on the marble gantry 14. The motor base 15 is installed on the Z axis 20 of the triaxial platform through bolts, and the motor 16 is clamped by the motor base 15. The tip tool 1 is installed on the motor 16 through a collet 21, and driven to rotate by the motor 16. The tip tool 1 is driven through the Z axis 20 to move along the axial direction of the micro lens array mold 3 so that the tip tool 1 can move along the polishing path 2 so as to better fit the shape of the micro lens array mold 3.

Step 4: setting polishing parameters.

The polishing parameters to be set mainly include the gap between the micro lens array mold 3 and the tip tool 1, the motion track 13 of the micro lens array mold 3 and the speed of the motor 16. The polishing gap between the micro lens array mold 3 and the tip tool 1 is adjusted through the Z axis 20 of the triaxial platform so that the tip tool 1 always moves along the polishing path 2 to better fit the shape of the micro lens array mold 3, so as to ensure no damage to the shape accuracy in the polishing process. The micro lens array mold 3 can carry out grid motion through the X axis 17 and the Y axis 18 of the triaxial platform according to the motion track 13 so that all the feature points 12 on the micro lens array mold 3 can be machined.

Specifically, the gap between the micro lens array mold 3 and the tip tool 1 is 50-100 μm; when the micro lens array mold 3 forms the motion track 13, the motion speed in the X direction and the Y direction is 2 mm/s; and the speed of the tip tool 1 is 300 rpm.

Step 5: starting polishing.

Step 6: conducting quality inspection of the mold.

The polished micro lens array mold 3 is inspected, including the size of the feature points 12 of the micro lens array mold, the surface roughness and topography after polishing, and the shape of the polished micro lens array mold 3, through a ZYGO white-light interferometer, an MITAKA surface profiler, an ultra-depth microscope, etc., to determine whether the machining requirements are met. If yes, the next step is executed; otherwise, step 5 is executed for polishing and inspection again until the machining requirements are met.

Step 7: finishing polishing.

### Embodiment 2

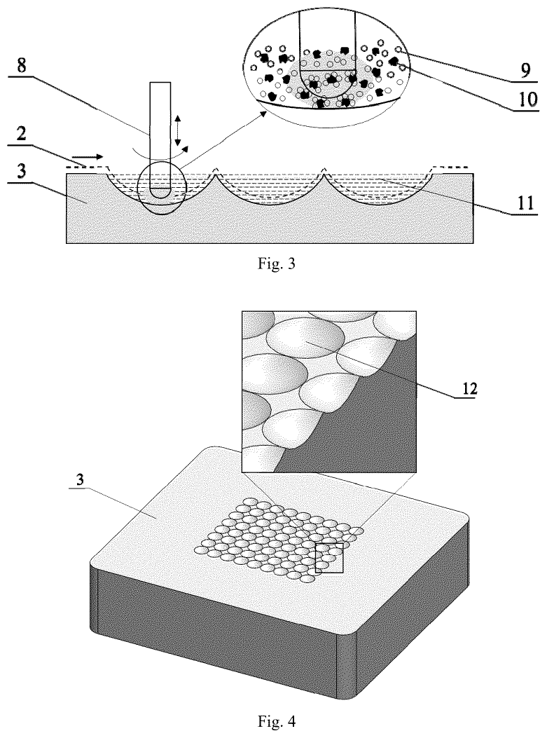

Referring to FIG. 1, FIG. 3, FIG. 4, FIG. 5 and FIG. 6, the device shown in FIG. 6 is used to perform conformal flexible polishing of the micro lens array mold 3 through the ball end tool 8 and the shear thickening slurry 11.

Step 1 is similar to that in embodiment 1.

Step 2: preparing the shear thickening slurry 11. Specifically, the shear thickening slurry comprises abrasive particles 10, a shear thickening phase and deionized water. The shear thickening phase is polyhydroxylated polymer 9, with the mass fraction of 45-52 wt %; the abrasive particles 10 are one or a combination of aluminum oxide, silicon carbide, diamond, cerium oxide and zirconium oxide, with the particle size of 1-10 μm and the proportion of 10-15 wt %; and the rest is deionized water. The abrasive particles 10, the shear thickening phase and the deionized water are mixed well by ultrasound in a certain proportion.

Steps 3-7 are similar to those in embodiment 1 except that the tip tool 1 is replaced with the ball end tool 19 and the magnetic slurry is replaced with the shear thickening slurry 11.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A conformal flexible polishing method for a micro lens array mold, comprising the following steps:
step 1: conducting initial inspection of a micro lens array mold
the initial conditions of the micro lens array mold to be machined are inspected, including the size, initial surface roughness and initial topography of feature points on the micro lens array mold, and the initial shape of the micro lens array mold, wherein the size of the feature points is in micron order;
step 2: preparing magnetic polishing slurry
when the machining tool is a tip tool, magnetic slurry shall be prepared: diamond abrasive and iron powder are mixed to obtain magnetic slurry, a coupling agent is added, and the diamond abrasive is bonded to the surface of the iron powder through the coupling agent;
step 3: installing tools
the magnetic slurry is placed on the upper surface of the micro lens array mold; the micro lens array mold is installed on a triaxial movement platform; the tip tool is installed on a motor so as to rotate; the bottom machining end of the tip tool is a tip end, which is magnetically conductive and possesses the ability of adsorbing magnetic slurry; a magnet is installed below the micro lens array mold so that the magnetic slurry is fitted with the surface of the workpiece under the action of magnetic field force to produce a contact pressure; and the motor is installed on the Z axis of the triaxial movement platform so as to move along the axial direction of the micro lens array mold;
step 4: setting polishing parameters and starting polishing
the polishing parameters to be set mainly include the gap between the micro lens array mold and the tip tool, the motion track of the micro lens array mold and the speed of the motor, wherein the polishing gap between the micro lens array mold and the tip tool is adjusted through the Z axis of the triaxial platform so that the tip tool always moves along a polishing path; and the micro lens array mold carries out XY two-dimensional planar motion through the triaxial platform according to the motion track;
the tip tool rotates, the magnetic slurry on the tip end of the tool forms a spherical polishing head under the action of magnetic force and centrifugal force, and the polishing head has flexibility to achieve the purpose of maintaining the shape of the micro lens array mold; material removal is achieved through the magnetic field force generated by the magnet below the workpiece on the magnetic slurry and the relative motion generated between the tip tool and the micro lens array mold after rotation to obtain a high-quality surface; and all the feature points of the micro lens array mold are polished by controlling the tip tool to move along the motion track;
step 5: conducting quality inspection of the mold
the polished micro lens array mold is inspected to determine whether the machining requirements are met; if yes, the process end; otherwise, step 4 is executed for polishing and inspection again until the machining requirements are met.

2. (canceled)

3. (canceled)

4. The conformal flexible polishing method for a micro lens array mold according to claim 1, wherein the diamond abrasive can be replaced with silicon dioxide, aluminum oxide or other abrasives based on the material of the micro lens array mold.

5. The conformal flexible polishing method for a micro lens array mold according to claim 1, wherein the method can add chemical action in the polishing process to introduce a chemical field for compounding.

6. The conformal flexible polishing method for a micro lens array mold according to claim 1, wherein the mass ratio of the diamond abrasive to the iron powder is 4:1 in step 2.

7. The conformal flexible polishing method for a micro lens array mold according to claim 1, wherein the additive amount of the coupling agent is 1 ml for every 5 g of magnetic slurry in step 2; and the coupling agent is silane coupling agent.

8. The conformal flexible polishing method for a micro lens array mold according to claim 1, wherein the particle size of the diamond abrasive is 3-5 μm in step 2.
